(19) United States
(12) Patent Application Publication
(10) Pub. No.: US 2022/0012386 A1
(43) Pub. Date: Jan. 13, 2022

(54) RISK CALCULATION APPARATUS, COMPUTER READABLE MEDIUM, AND RISK CALCULATION METHOD

(71) Applicant: Mitsubishi Electric Corporation, Tokyo (JP)

(72) Inventors: Taiki KOBAYASHI, Tokyo (JP); Tomooki UKIANA, Tokyo (JP)

(73) Assignee: Mitsubishi Electric Corporation, Tokyo (JP)

(21) Appl. No.: 17/484,168

(22) Filed: Sep. 24, 2021

Related U.S. Application Data
(63) Continuation of application No. PCT/JP2019/013370, filed on Mar. 27, 2019.

(51) Int. Cl. G06F 30/20; G06Q 30/00

(52) U.S. Cl. CPC G06F 30/20; G06Q 30/016

(57) ABSTRACT

A facility risk calculation unit calculates, from a result of calculation of a thermal environment, a risk index value (rᵢ) indicating at least either of a degree of difference (a*g(αᵢ₋₁, αᵢ)) indicating a difference between a calculated temperature (Cᵢ) obtained by the calculation of the thermal environment with respect to a set temperature (Sᵢ) and a target value (Sᵢ) and a degree of change (b*g(βᵢ₋₁, βᵢ)) indicating a value of a change of the calculated target value (Cᵢ) with respect to time. A display processing unit causes a facility risk (R) obtained from the risk index value (rᵢ) to be displayed on a display apparatus.

### CROSS REFERENCE TO RELATED APPLICATIONS

This application is a Continuation of PCT International Application No. PCT/JP2019/013370, filed on Mar. 27, 2019, which is hereby expressly incorporated by reference into the present application.

### TECHNICAL FIELD

The present invention relates to a risk calculation apparatus, risk calculation program, and risk calculation method of calculating, by simulating a thermal environment air-conditioned by an air-conditioning facility, a risk of receiving a complaint (claim) from a user of the air-conditioning facility because of a capacity shortage of the air-conditioning facility.

### BACKGROUND ART

In conventional techniques, there is a technique capable of calculating a thermal load to be processed for each unit time and an unprocessed thermal load not processed due to a capacity shortage of an air-conditioning facility (for example, Patent Literature 1). In an air-conditioning facility in which energy efficiency at the time of partially-loaded driving is lower than energy efficiency at the time of rated driving, air-conditioning capacity and the amount of energy consumption have a trade-off relation. If a model of air-conditioning facility with low air-conditioning capacity is selected by prioritizing energy conservation, the capacity of the air-conditioning facility runs short, and a risk of occurrence of a claim from a user increases.

However, the conventional technique has a problem in which it is not quantitatively evaluated how much the unprocessed thermal load is involved in the risk of receiving a claim from the user and, therefore, for final model of air-conditioning facility selection, there is no other measure than selecting a model of air-conditioning facility by an architect of the air-conditioning facility with his or her empirical rule.

### CITATION LIST

### Patent Literature

Patent Literature 1: JP H5-93538

### SUMMARY OF INVENTION

### Technical Problem

An object of this invention is to provide an apparatus which presents information which allows selection of a model of air-conditioning facility of an air-conditioning facility without requiring experiences of the architect of the air-conditioning facility.

### Solution to Problem

A risk calculation apparatus according to the present invention includes
a data obtaining unit to obtain simulation data including specification data of an air-conditioning facility, architectural data of a building to be air-conditioned by the air-conditioning facility, and a target value serving as a target for air-conditioning of the building by the air-conditioning facility, the simulation data being used in calculation of a thermal environment of the building;
a thermal environment calculation unit to calculate, by using the simulation data, the thermal environment of the building to be air-conditioned by the air-conditioning facility;
a facility risk calculation unit to calculate a facility risk by using the result of calculation of the thermal environment, the facility risk indicating at least either of a degree of difference indicating a difference between a calculated target value obtained by the calculation of the thermal environment with respect to the target value and the target value and a degree of change indicating a value of a change of the calculated target value with respect to time; and
an output unit to output the facility risk.

### Advantageous Effects of Invention

The risk calculation apparatus of the present invention converts, into a numerical form, a risk of receiving a complaint from a user of the air-conditioning facility because of a capacity shortage of the air-conditioning facility, and thus can present information which allows selection of a model of air-conditioning facility without depending on the empirical rule of the architect of the facility.

### BRIEF DESCRIPTION OF DRAWINGS

FIG. 1 is a diagram of Embodiment 1, illustrating functional blocks of a risk calculation apparatus 101.

FIG. 2 is a diagram of Embodiment 1, illustrating the hardware structure of the risk calculation apparatus 101.

FIG. 3 is a diagram of Embodiment 1, being a flowchart for describing the operation of the risk calculation apparatus 101.

FIG. 4 is a diagram of Embodiment 1, illustrating simulation data to be inputted to a data obtaining unit 10.

FIG. 5 is a diagram of Embodiment 1, describing a method of calculating a capacity shortage risk index rᵢ.

FIG. 6 is a diagram of Embodiment 1, schematically describing the method of calculating the risk index rᵢ.

FIG. 7 is a diagram of Embodiment 1, describing a method of calculating a capacity shortage facility risk R.

FIG. 8 is a diagram of Embodiment 1, illustrating a display mode of an energy-conservation target attainment degree and the facility risk R.

FIG. 9 is a diagram of Embodiment 1, illustrating the functional structure of a risk calculation apparatus 102 of a modification example.

FIG. 10 is a diagram of Embodiment 1, illustrating the hardware structure of the risk calculation apparatus 102.

FIG. 11 is a diagram of Embodiment 1, being a flowchart illustrating the operation of the risk calculation apparatus 102.

FIG. 12 is a diagram of Embodiment 1, illustrating a display mode for displaying facilities before and after change.

FIG. 13 is a diagram of Embodiment 1, illustrating a mode in which decision buttons are displayed on a display apparatus 200.

FIG. 14 is a diagram of Embodiment 1, illustrating a structure in which the functions of the risk calculation apparatuses 101 and 102 are implemented by hardware.

### DESCRIPTION OF EMBODIMENTS

In the following, an embodiment of the present invention is described by using the drawings. Note that identical or corresponding portions are provided with the same reference character. In the description of the embodiment, description of an identical or corresponding portion is omitted or simplified as appropriate.

### Embodiment 1

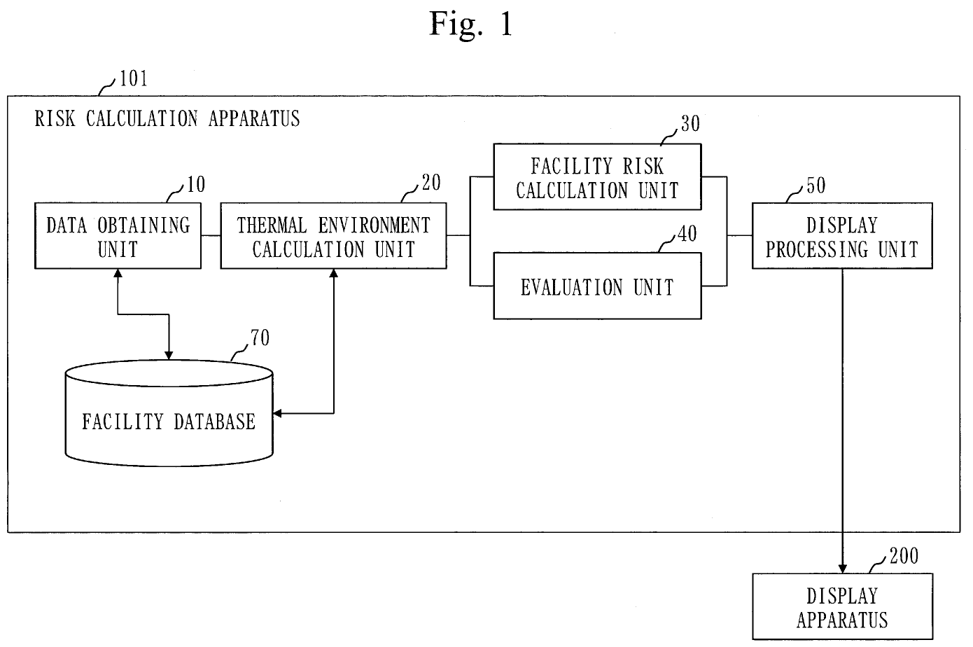

With reference to FIG. 1 to FIG. 14, a risk calculation apparatus 101 and a risk calculation apparatus 102 of Embodiment 1 are described.

***Description of Configuration***

FIG. 1 illustrates functional blocks of the risk calculation apparatus 101.

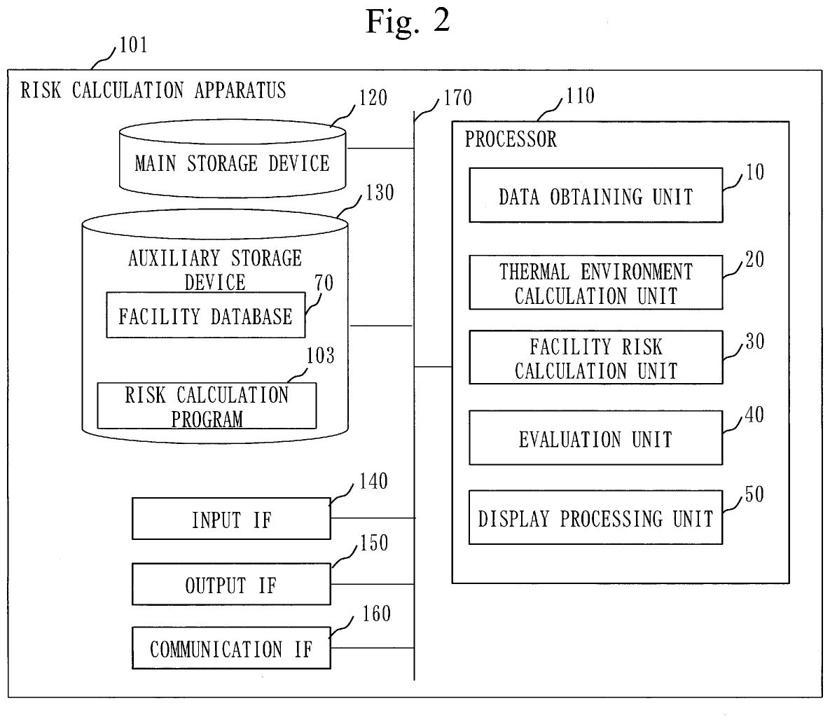

FIG. 2 illustrates the hardware structure of the risk calculation apparatus 101. With reference to FIG. 2, the hardware structure of the risk calculation apparatus 101 is described.

The risk calculation apparatus 101 is a computer. The risk calculation apparatus 101 includes a processor 110 and also includes other pieces of hardware such as a main storage device 120, an auxiliary storage device 130, an input IF 140, an output IF 150, and a communication IF 160. The processor 110 is connected to the other pieces of hardware through a signal line 170 to control these other pieces of hardware.

The risk calculation apparatus 101 includes, as functional components, a data obtaining unit 10, a thermal environment calculation unit 20, a facility risk calculation unit 30, an evaluation unit 40, and a display processing unit 50. The display processing unit 50 is an output unit. The functions of the data obtaining unit 10, the thermal environment calculation unit 20, the facility risk calculation unit 30, the evaluation unit 40, and the display processing unit 50 are implemented by a risk calculation program 103.

The processor 110 is a device which executes the risk calculation program 103. The risk calculation program 103 is a program which implements the functions of the data obtaining unit 10, the thermal environment calculation unit 20, the facility risk calculation unit 30, the evaluation unit 40, and the display processing unit 50. The processor 110 is an IC (Integrated Circuit) which performs an arithmetic process. Specific examples of the processor 110 are a CPU (Central Processing Unit), DSP (Digital Signal Processor), and GPU (Graphics Processing Unit).

The main storage device 120 is a storage device. Specific examples of the main storage device 120 are a SRAM (Static Random Access Memory) and DRAM (Dynamic Random Access Memory). The main storage device 120 retains the results of the arithmetic operation of the processor 110.

The auxiliary storage device 130 is a storage device which saves data in a non-volatile manner. A specific example of the auxiliary storage device 130 is an HDD (Hard Disk Drive). Also, the auxiliary storage device 130 may be a portable recording medium such as an SD (registered trademark) (Secure Digital) memory card, NAND flash, flexible disc, optical disc, compact disc, Blu-ray (registered trademark) disc, or DVD (Digital Versatile Disk). The auxiliary storage device 130 has stored therein a facility database 70 where simulation data is stored and the risk calculation program 103.

The input IF 140 is a port to which data is inputted from each device. The output IF 150 is a port to which various devices are connected and through which data is outputted by the processor 110 to various devices. In FIG. 2, to the output IF 150, a display apparatus 200 is connected. The communication IF 160 is a communication port for the processor to communicate with another device.

The processor 110 loads the risk calculation program 103 from the auxiliary storage device 130 into the main storage device 120, and reads the risk calculation program 103 from the main storage device 120 for execution. In the main storage device 120, not only the risk calculation program 103 but also an OS (Operating System) is stored. While executing the OS, the processor 110 executes the risk calculation program 103. The risk calculation apparatus 101 may include a plurality of processors which replace the processor 110. The plurality of these processors share the execution of the risk calculation program 103. As with the processor 110, each processor is a device which executes the risk calculation program 103. Data, information, a signal value, and a variable value to be used, processed or outputted by the risk calculation program 103 are stored in the main storage device 120, the auxiliary storage device 130, or a register or cache memory in the processor 110.

The risk calculation program 103 is a program which causes a computer to perform each of processes, procedures, or steps by reading the “units” of the data obtaining unit 10, the thermal environment calculation unit 20, the facility risk calculation unit 30, the evaluation unit 40, and the display processing unit 50 as the “processes”, “procedures”, or “steps”.

Also, a risk calculation method is a method to be performed by the risk calculation apparatus 101 as a computer executing the risk calculation program 103. The risk calculation program 103 may be provided as being stored in a computer-readable recording medium or may be provided as a program product.

***Description of Operation***

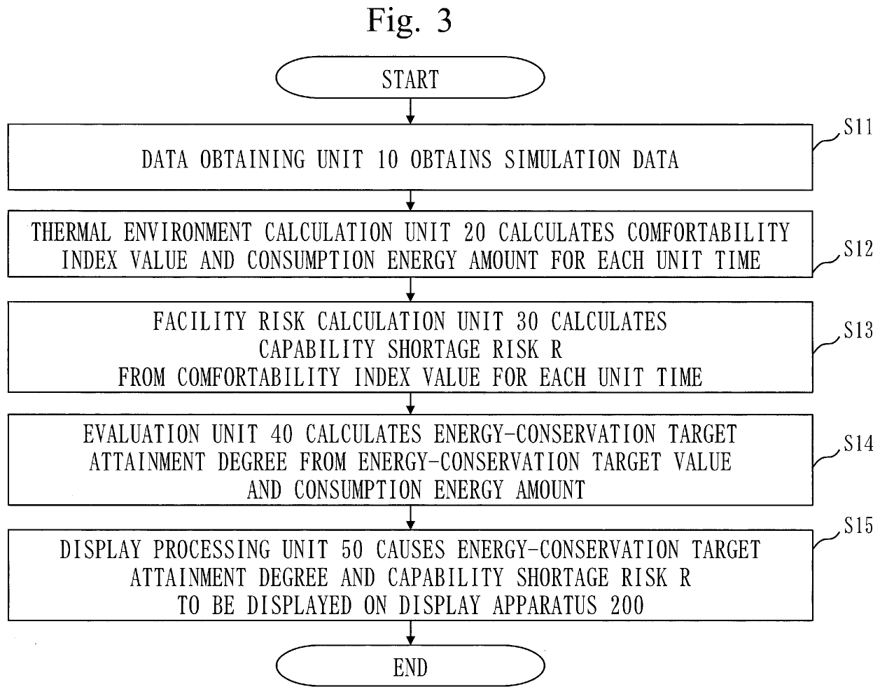

With reference to FIG. 3, the operation of the risk calculation apparatus 101 is described.

FIG. 3 is a flowchart describing the operation of the risk calculation apparatus 101. The operation of the risk calculation apparatus 101 corresponds to the risk calculation method. Also, the operation of the risk calculation apparatus 101 corresponds to the process of the risk calculation program.

<Step S11>

At step S11, the data obtaining unit 10 obtains simulation data.

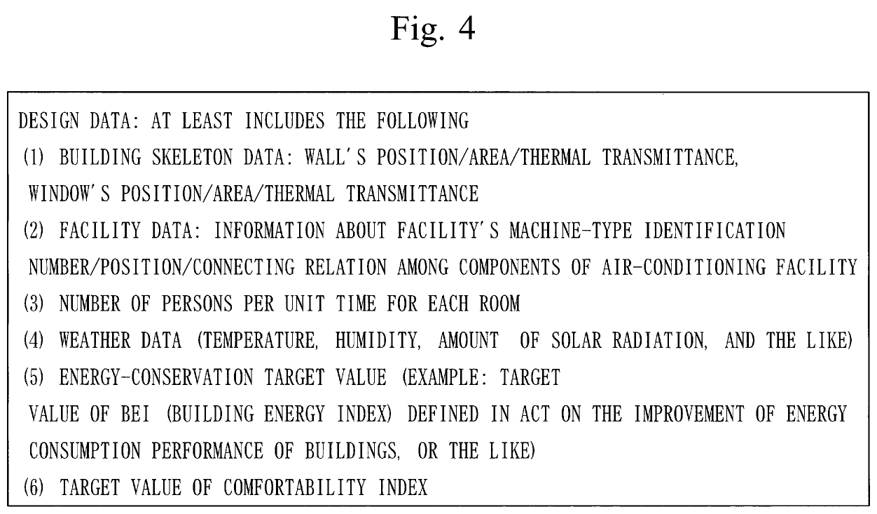

FIG. 4 illustrates simulation data to be inputted to the data obtaining unit 10. To the data obtaining unit 10, building design data is inputted as simulation data of a building to be processed. The data obtaining unit 10 registers the obtained building design data in the facility database 70.

The simulation data is used for calculation of the thermal environment of the building.

Calculation of the thermal environment of the building is performed by the thermal environment calculation unit 20, which will be described further below. The thermal environment is an environment in the building, including temperature distribution and temperature changes. Building design data, which is simulation data, includes:
(a) specification data of an air-conditioning facility;
(b) architectural data of a building to be air-conditioned by the air-conditioning facility; and
(c) a target value serving as a target for air-conditioning of the building by the air-conditioning facility.
(a) Specification data of the air-conditioning facility corresponds to (2) described below,
(b) architectural data of the architecture to be air-conditioned by the air-conditioning facility corresponds to (1) described below, and
(c) the target value serving as a target of air-conditioning of the architecture by the air-conditioning facility corresponds to (6) described below.

The design data of FIG. 4 includes data of the following (1) to (6).

(1) Architectural schematic data:
The architectural schematic data consists of the position of a wall, the area of the wall, thermal transmittance of the wall, the position of a window, the area of the window, and thermal transmittance of the window in the building.
   (2) Facility data:
The facility data includes information about a model identification number of the air-conditioning facility, the position of the air-conditioning facility, and a connecting relation among the components of the air-conditioning facility.
   (3) Number of people per unit time for each room.
   (4) Weather data such as temperature, humidity, and amount of solar radiation:
As the weather data, statistical data can be used.
   (5) Energy-conservation target value:
As an energy-conservation target value, an example is a target value of a BEI (Building Energy Index) defined in the Act on the Improvement of Energy Consumption Performance of Buildings. A value such as BEI=0.5 shall be inputted.
   (6) Driving condition of the air-conditioning facility:
As a driving condition of the air-conditioning facility, there is a set temperature. In cooling mode, the set temperature has a value such as a temperature=26 degrees Celsius. Also, the driving condition may be set with a comfortability index value such as PMV (Predicted Mean Vote).

<Step S12>

At step S12, by using the simulation data, the thermal environment calculation unit 20 calculates a thermal environment of the building to be air-conditioned by the air-conditioning facility.

Specifically, the thermal environment calculation unit 20 calculates a comfortability index value and amount of an energy consumption for each unit time by thermal environment calculation.

<Step S13>

At step S13, by using the thermal environment calculation result, the facility risk calculation unit 30 calculates a facility risk including at least either of a degree of difference indicating a difference between a calculated target value obtained by thermal environment calculation with respect to the target value and the target value and a degree of change indicating a value of a change of the calculation target value with respect to time.

The calculated target value, the degree of difference, the degree of change, and the facility risk will be descried further below. The facility risk calculation unit 30 calculates a facility risk R from the comfortability index value for each unit time. The facility risk R will be described further below.

<Step S14>

At step S14, the evaluation unit 40 calculates an energy-conservation target attainment degree from the energy-conservation target value and the amount of energy consumption. While the thermal environment calculation unit 20 calculates an amount of energy consumption by the air-conditioning facility based on thermal environment calculation, by using the amount of energy consumption calculated based on thermal environment calculation, the evaluation unit 40 calculates an effect of reduction of amount of the energy consumption by the air-conditioning facility as an energy-conservation target attainment degree.

<Step S15>

At step S15, the display processing unit 50, which is an output unit, outputs the facility risk R Also, the display processing unit 50 outputs the reduction effect. Specifically, the display processing unit 50 causes the energy-conservation target attainment degree, which is the reduction effect, and the facility risk R to be displayed on the display apparatus 200.

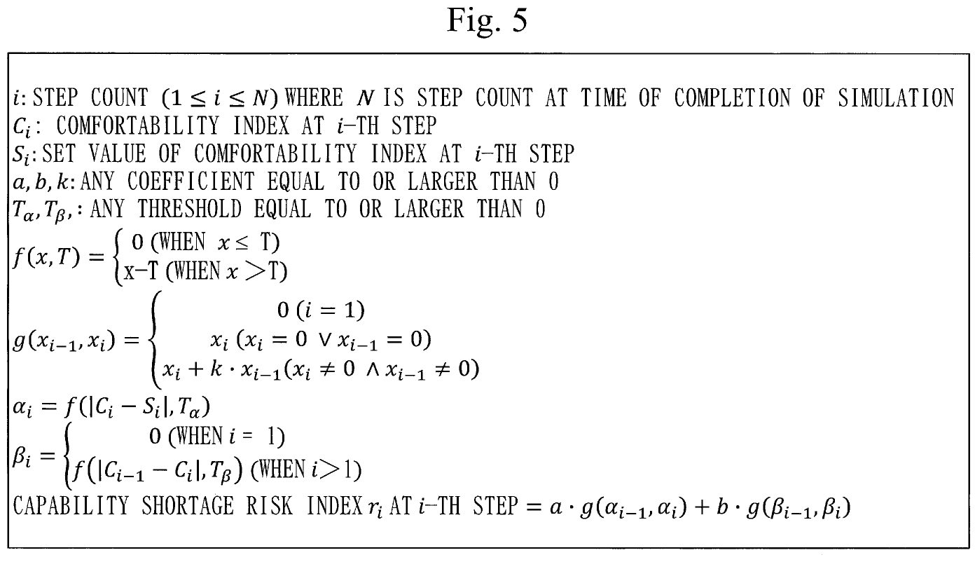

With reference to FIG. 5 to FIG. 8, details of step S13 are elaborated.

FIG. 5 illustrates a method of calculating a capacity shortage risk index rᵢ. The capacity shortage risk index r is hereinafter denoted as a risk index rᵢ.

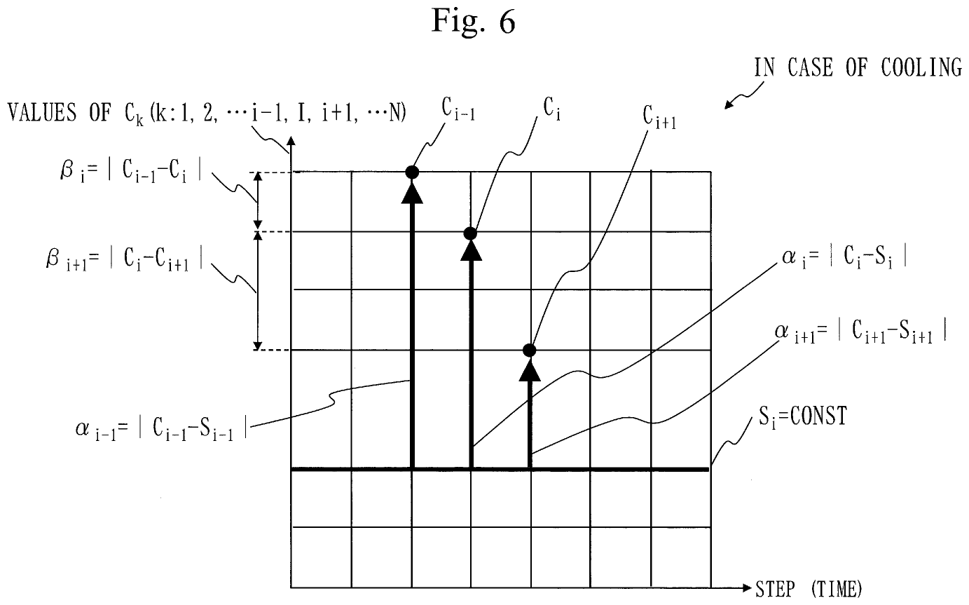

FIG. 6 schematically illustrates the risk index rᵢ.

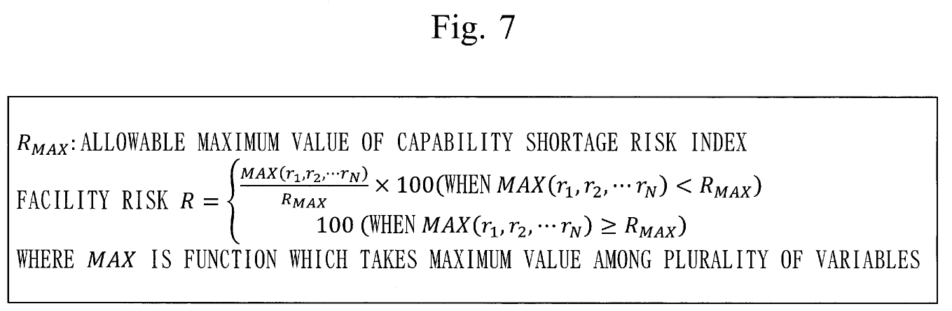

FIG. 7 illustrates a method of calculating a capacity shortage risk R. The capacity shortage risk R is hereinafter denoted as a risk R.

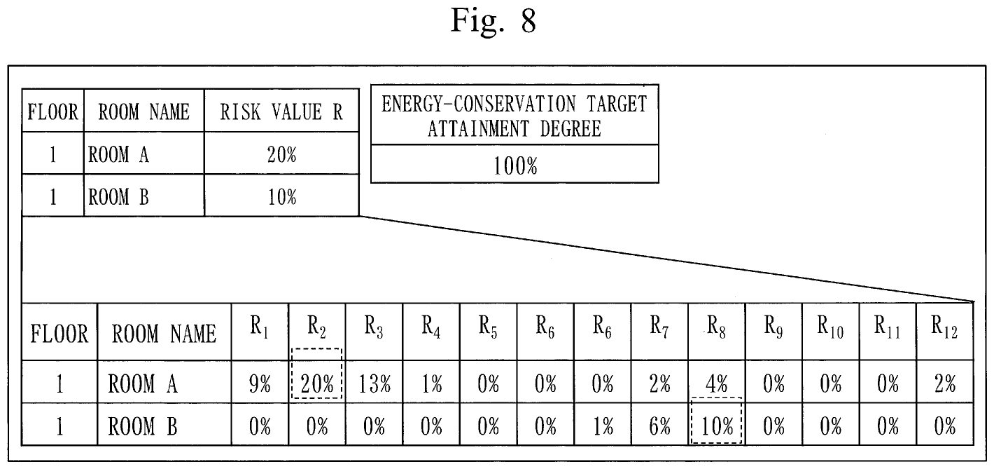

FIG. 8 illustrates a display mode of an energy-conservation target attainment degree and the risk R.

<Calculation of Risk Index rᵢ>

With reference to FIG. 5, a method of calculating the risk index n is described. First, signs are defined as follows.

The comfortability index in the following (2) is set as a temperature obtained by thermal environment calculation with respect to the set temperature.

The set value of the comfortability index in the following (3) is set as a set temperature. Also, a simulation for use in the following refers to thermal environment calculation by the thermal environment calculation unit 20.

(1) i: step count (1≤i≤N).
Here, N is a step count at the time of completion of the simulation.
i is associated with time, and as its value becomes larger, i corresponds to a later time. That is, in i and i+1, i is associated with a more previous time than i+1.
   (2) Ci: a comfortability index at an i-th step.
   (3) Sᵢ: a set value of the comfortability index at the i-th step.
   (4) a, b, k: any coefficient equal to or larger than 0.
   (5) T_{α}, T_{β}: any threshold equal to or larger than 0.

As illustrated in FIG. 5, the risk index rᵢ is defined by an f function and a g function. Here, as illustrated in FIG. 5, the f function is 0 when x is equal to or smaller than T and x-T when x is larger than T. Also, as for the g function,

when i=1, g(xᵢ₋₁, xᵢ)=0.
When at least one of xᵢ₋₁ and xᵢ is 0.

g(xᵢ₋₁,xᵢ)=xᵢ.

When neither xᵢ₋₁ nor xᵢ is 0,

g(xᵢ₋₁,xᵢ)=xᵢ+k*xᵢ₋₁.

The risk index rᵢ for the i steps is calculated by

rᵢ=a*g(αᵢ₋₁,αᵢ)+b*g(βᵢ₋₁,βᵢ).

Here,

αᵢ=f(|Cᵢ−Sᵢ|,T_{α})

βᵢ=0(i=1),

βᵢ=f(|Cᵢ₋₁−Cᵢ|,T_{β})(i>1).

With reference to FIG. 6, the risk index n is described.

For simplification, it is assumed that

T_{α}=T_{β}=0,a=b=k=1, and Sᵢ=constant.

Temperature is used as an instance of comfortability index.

FIG. 6 shows the case of cooling operation. FIG. 6 illustrates a state in which calculated temperatures Cᵢ₋₁, Cᵢ, Cᵢ₊₁ approach the set temperature Sᵢ. As for the calculated temperature Cᵢ₋₁, an arrow taking the set temperature Sᵢ as a starting point indicates αᵢ₋₁. Also as for the calculated temperatures Cᵢ and Cᵢ₊₁, the case of the calculated temperature Cᵢ₊₁ applies. Also, βᵢ is a difference between the calculated temperature Cᵢ₋₁ and the calculated temperature Cᵢ. βᵢ₊₁ is a difference between the calculated temperature Cᵢ and the calculated temperature Cᵢ₊₁.

In this case,

rᵢ=g(αᵢ₋₁,αᵢ)+g(βᵢ₋₁,βᵢ)=

[αᵢ+αᵢ₋₁]+[βᵢ+βᵢ₋₁].

When ΔTᵢ=αᵢ=|Cᵢ−Sᵢ|, and

ΔCᵢ=βᵢ=Cᵢ₋₁—Cᵢ|,

rᵢ=[ΔTᵢ+ΔTᵢ₋₁]+[ΔCᵢ+ΔCᵢ₋₁].

That is, in rᵢ, [ΔTᵢ+ΔTᵢ₋₁] is a degree of difference indicating a difference between the calculated target value Cᵢ indicating the calculation result of the set value Sᵢ, which is a target value obtained by a simulation, and the set value Sᵢ.

Also, in rᵢ, [ΔCᵢ+ΔCᵢ₋₁] is a degree of change indicating a value of a change of the calculated temperature Cᵢ, which is the calculated target value, with respect to time.

And, as for rᵢ,

in rᵢ=a*g(αᵢ₋₁,αᵢ)+b*g(βᵢ₋₁,βᵢ).

when b=0,

rᵢ=a*g(αᵢ₋₁,αᵢ), and

when a=0,

rᵢ=b*g(βᵢ₋₁,βᵢ).

Thus, the risk index rᵢ indicates at least either of the degree of difference and the degree of change.

Also, the facility risk R described below is obtained by multiplying the maximum risk index n by the inverse of a constant R_{MAX}.

Thus, since the facility risk R is also the risk index rᵢ in substance, the facility risk R indicates at least either of the degree of difference and the degree of change.

Here.

rᵢ=a*g(αᵢ₋₁,αᵢ)+b*g(βᵢ₋₁,βᵢ)

can be thought as a risk of receiving a complaint from a user of the air-conditioning facility because of a capacity shortage of the air-conditioning facility.

That is, the risk index rᵢ indicates a risk of a user claim by the user of the air-conditioning facility and, as the risk index rᵢ becomes larger, the possibility of occurrence of a user claim becomes higher.

The risk index rᵢ can be thought as a user claim risk index as follows.

a*g(αᵢ₋₁, αᵢ) in the risk index rᵢ becomes larger as a difference between the set value Sᵢ and the calculated target value Cᵢ becomes larger.

When temperature is taken as an example, as a difference between the set temperature and the calculated temperature becomes larger, a*g(αᵢ₋₁, αᵢ) becomes larger. When the difference between the set temperature and the calculated temperature is large, that is, when a*g(αᵢ₋₁, αᵢ) is large, the users of the air-conditioning facility feel uncomfortable, and the risk of a user claim is increased.

Also, b*g(βᵢ₋₁, βᵢ) in the risk index rᵢ indicates a change in the calculated target value Cᵢ over three steps, and becomes larger as a difference in the calculated target values between steps becomes larger. When temperature is taken as an example, as a temperature change between steps, that is, with respect to time, becomes larger, b*g(βᵢ₋₁, βᵢ) becomes larger. When the temperature change is large, that is, when b*g(βᵢ₋₁, βᵢ) is large, the users of the air-conditioning facility feel uncomfortable, and the risk of a user claim is increased.

Thus,

rᵢ=a*g(αᵢ₋₁,αᵢ)+b*g(βᵢ₋₁,βᵢ)

indicates a risk of a user claim by the user of the air-conditioning facility.

Also, since the substance of the facility risk R is the risk index rᵢ, the facility risk R is also a value indicating a risk of a user claim by the user of the air-conditioning facility. The facility risk R is a risk of a user claim. That is, the facility risk R indicates a risk of occurrence of a user claim by taking a capacity shortage of the air-conditioning facility as a precondition.

As can be seen from FIG. 6, as for α=f(|Cᵢ−Sᵢ|, T_{α}), as the calculated temperature Cᵢ calculated by the simulation becomes farther away from the set temperature Sᵢ, the risk index rᵢ becomes a value indicating a higher risk. Also, as for βᵢ=f(|Cᵢ₋₁−Cᵢ|, T_{β}), as the change of the calculated temperature Cᵢ calculated by the simulation becomes sharper and the change continues longer, the risk index rᵢ becomes a value indicating a higher risk.

The f function extracts a state with a risk, and the g function evaluates that risk highly when the state with the risk continues.

With this mechanism, not only a clear behavior such as not cooling or not heating but also a state such as being difficult to cool or being difficult to heat can be evaluated by the g function, and a capacity shortage risk can be accurately grasped.

Note that while g(αᵢ₋₁, αᵢ) is targeted for consecutive two steps and (βᵢ₋₁, βᵢ) is targeted for consecutive three steps, an equation targeted for three or more steps may be used for g(αᵢ₋₁, αᵢ) and an equation targeted for four or more steps may be used for (βᵢ₋₁, βᵢ).

That is, the thermal environment calculation unit 20 calculates, for each step associated with time, a thermal environment, and the facility risk calculation unit 30 calculates one degree of difference targeted for a plurality of consecutive steps. In FIG. 6, the facility risk calculation unit 30 calculates one degree of difference targeted for consecutive two steps.

Also, the thermal environment calculation unit 20 calculates a thermal environment for each step associated with time, and the facility risk calculation unit 30 calculates one degree of change targeted for a plurality of consecutive steps. In FIG. 6, the facility risk calculation unit calculates one degree of change targeted for consecutive three steps.

With reference to FIG. 7, a method of calculating the risk R is described. The facility risk calculation unit 30 has an allowable maximum value of the risk index rᵢ as R_{MAX}. Among risk indexes r₁, r₂ . . . rₙ, calculated from the i step to the N step, if every value is smaller than R_{MAX}, the facility risk calculation unit 30 calculates the risk R as follows. The facility risk calculation unit 30 takes a percentage of the maximum risk index among the risk indexes r₁, r₂ . . . rₙ with respect to R_{MAX} as the risk R. If the maximum risk index is 20 among the risk indexes r₁, r₂ . . . rₙ, and R_{MAX} is 200, the risk R is 10%.

Also, if any value among the risk indexes r₁, r₂ . . . rₙ calculated from the i step to the N step is equal to or larger than R_{MAX}, the facility risk calculation unit 30 sets the risk R at 100%.

With reference to FIG. 8, the evaluation result calculated by the evaluation unit 40 is described. At step S14, from the energy-conservation target value and the amount of energy consumption, the evaluation unit 40 calculates an energy-conservation target attainment degree. As an energy-conservation target attainment degree, the evaluation unit 40 calculates, for example, a BEI defined in the following reference document.

<Reference Document> Method and Commentary of Calculation and Determination in Conformity with Energy-Conservation Standards in 2013, I. Non-Residential Architecture (Second Edition).

The evaluation unit 40 compares a designed BEI and the target BEI inputted in (5) of FIG. 4 and, from the comparison result, calculates an energy-conservation target attainment degree. The evaluation unit 40 calculates an energy-conservation target attainment degree from, for example, a ratio between the designed BEI and the target BEI. When the designed BEI=0.4 and the target BEI=0.5, the evaluation unit 40 calculates an energy-conservation target attainment degree as 80%. In FIG. 8, since the energy-conservation target attainment degree is 100%, the designed BEI=the target BEI.

Also, FIG. 8 illustrates a display mode in which the display processing unit 50 causes display on the display apparatus 200. A table in FIG. 8 illustrates the risk R for each month of twelve months as for a room A and a room B. In this manner, with tabulation to calculate the risk R for each month, temporal distribution of the risk R can be found. This makes it easy to determine whether the cooling capacity or the heating capacity is to be enhanced. While the example is described in FIG. 8 in which tabulation is made for each month, another time granularity such as day or hour may be set. Also, the display mode may be a tabular form or graph form. Furthermore, as illustrated on upper left in FIG. 8, with the risks R in one year being presented for each room, it is possible to consider, for each room, of which room the capacity of the air-conditioner is to be decreased or increased.

The simulation data inputted to the data obtaining unit 10 may include use-purpose information indicating the use purpose of a room to be air-conditioned by the air-conditioning facility. The facility risk calculation unit 30 corrects the risk R, which is a facility risk, in accordance with the type of the use-purpose information. Specifically, the facility risk calculation unit 30 multiplies the risk R by a coefficient Kᵤ in accordance with the use purpose of the room indicated by the use-purpose information. With this correction of the risk R, for a building such as a warehouse where people are not always present, multiplication by Kᵤ smaller than that for an office where people are always present is made to decrease the risk R, thereby allowing a practical risk determination to be made.

### Description of Effects of Embodiment 1

(1) According to the risk calculation apparatus 101, at the time of designing a building where energy performance is defined as a requirement, the capacity shortage risk R of the air-conditioning facility can be quantitatively evaluated. Thus, at the time of designing the building, rational energy-conservation designing can be made.
(2) According to the risk calculation apparatus 101, since the capacity shortage risk R in the air-conditioning facility can be quantitatively evaluated, facility designing with excessive capacity precluded can be made with reference to the risk R.

### Modification Example

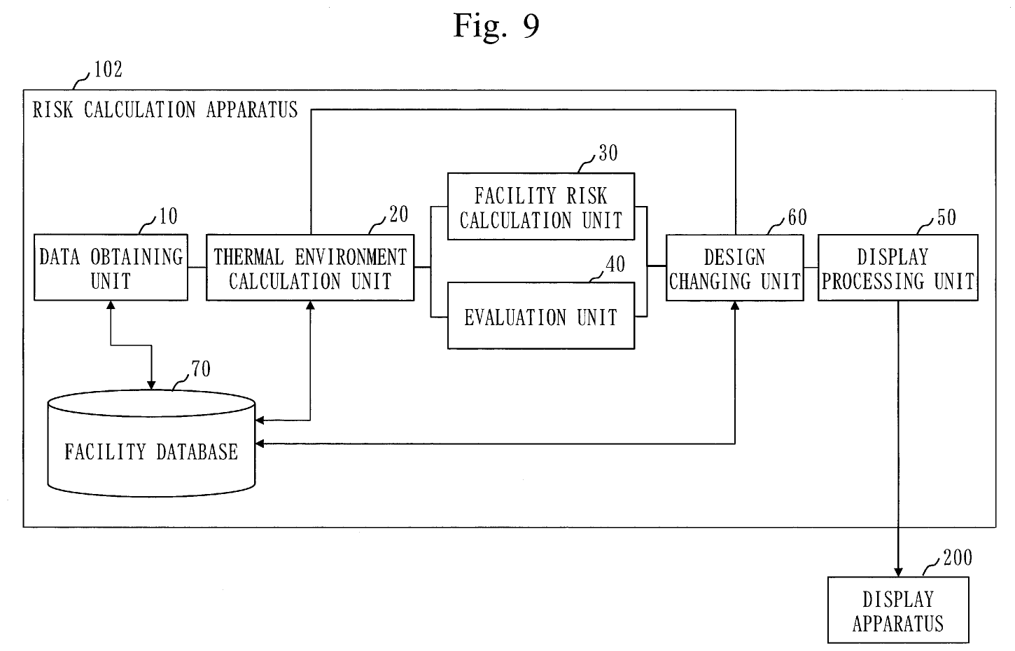

With reference to FIG. 9 to FIG. 12, the risk calculation apparatus 102 is described, which is a modification example of the risk calculation apparatus 101 of Embodiment 1.

FIG. 9 illustrates the functional structure of the risk calculation apparatus 102. The functional structure of the risk calculation apparatus 102 is different from the risk calculation apparatus 101 in having a design changing unit 60.

If the energy-conservation target attainment degree indicating the reduction effect has not attained the reduction target, the design changing unit 60 extracts another facility capable of replacing part of facilities included in the air-conditioning facility. The display processing unit 50 which is an output unit causes the extracted other facility to be displayed on the display apparatus 200.

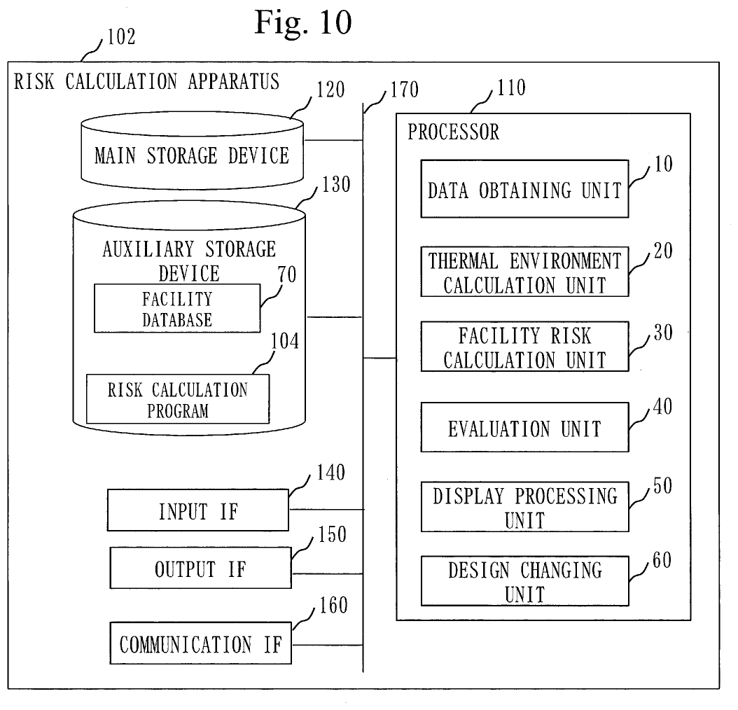

FIG. 10 illustrates the hardware structure of the risk calculation apparatus 102. In contrast to the hardware structure of the risk calculation apparatus 101 of FIG. 2, in The FIG. 10, the processor 110 further has the design changing unit 60 as a functional component. The functions of the data obtaining unit 10, the thermal environment calculation unit 20, the facility risk calculation unit 30, the evaluation unit 40, the display processing unit 50, and the design changing unit 60 are implemented by the processor 110. A risk calculation program 104 which implements the functions of the data obtaining unit 10, the thermal environment calculation unit 20, the facility risk calculation unit 30, the evaluation unit 40, the display processing unit 50, and the design changing unit 60 is stored in the auxiliary storage device 130. The risk calculation program 104 may be provided as being stored in a computer-readable recording medium or may be provided as a program product.

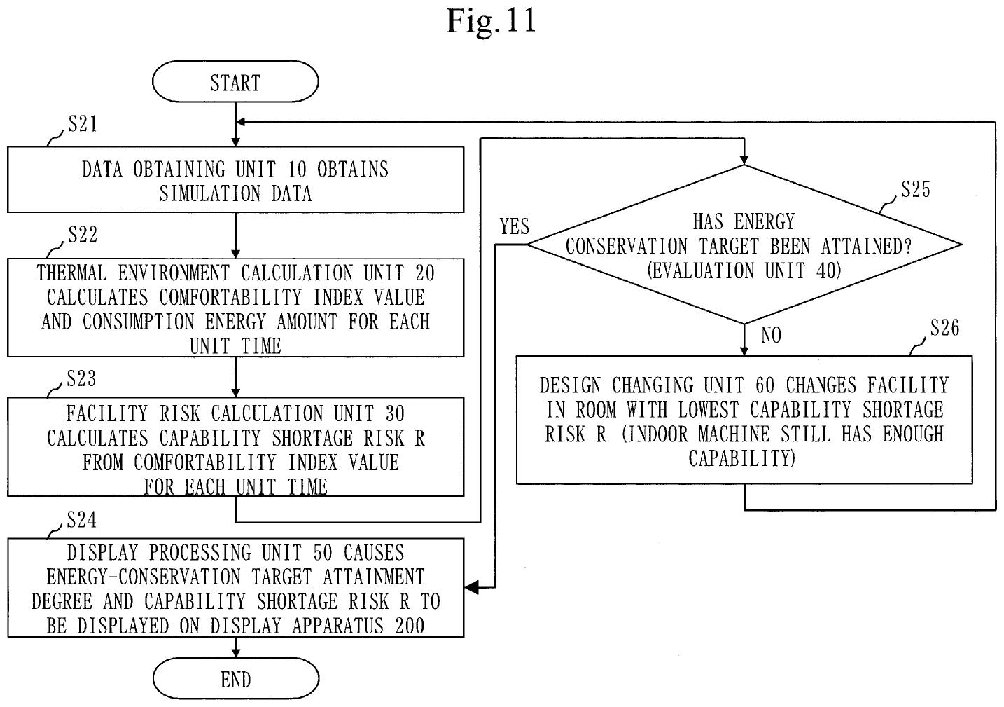

FIG. 11 is a flowchart illustrating the operation of the risk calculation apparatus 102 including the design changing unit 60. With reference to FIG. 11, the operation of the risk calculation apparatus 102 is described. Since step S21 to step S24 of FIG. 11 are identical to step S11 to step S14 of FIG. 3, step S25 and step S26 are described.

At step S25, the evaluation unit 40 determines whether the simulation result has attained the energy-conservation target. When the evaluation unit 40 determines that the simulation result has attained the energy-conservation target, the process proceeds to step S24 and, after the process at step S24, the process ends.

When the evaluation unit 40 determines that the simulation result has not attained the energy-conservation target (NO at step S25), the design changing unit 60 changes the facility in a low-risk room with the lowest risk R. Since the facility in the low-risk room with the lowest risk R can be thought to still have enough air-conditioning capacity, the design changing unit 60 extracts the facility with low air-conditioning capacity, which has a large energy-conservation effect, as a current facility. When NO at step S25, a series of processes of design changing, simulation after the design change, and checking whether the energy-conservation target has been achieved is repeated.

According to the risk calculation apparatus 102, the energy-conservation target can be attained, and a design with the lowest facility risk R can be asymptotically obtained.

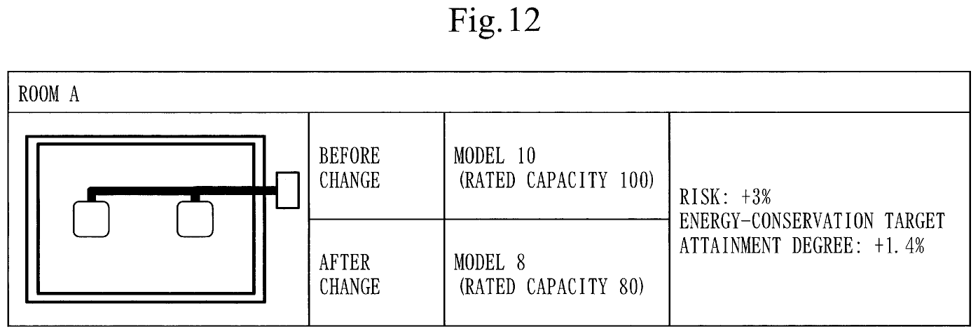

FIG. 12 illustrates a display mode in which, when the design changing unit 60 changes the facilities, the display processing unit 50 causes the facilities before and after change to be displayed on the display apparatus 200. As illustrated in FIG. 12, the display processing unit 50 causes, for each room, a changed part and change details to be displayed on the display apparatus 200, displaying both an amount of change in the risk R and an amount of change in the energy-conservation target attainment degree by the change. In FIG. 12, while the rated capacity of the facility before change is 100, the rated capacity of the facility after change is 80. Thus, the energy-conservation target attainment degree is +1.4% and the risk R is +3%.

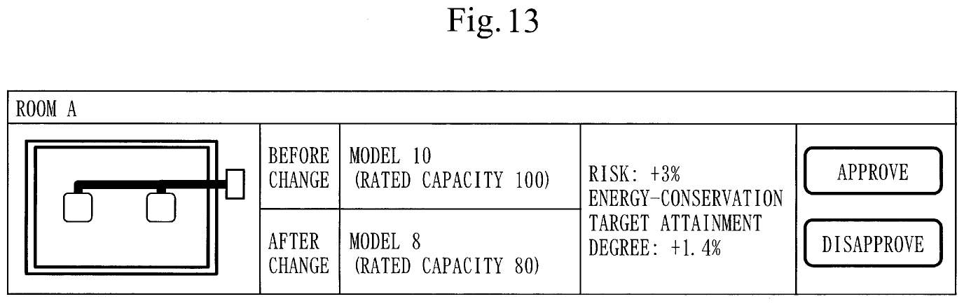

FIG. 13 illustrates a mode in which the display processing unit 50, which is an output unit, causes decision buttons for asking for a decision about whether to adopt the extracted other facility to be displayed on the display apparatus 200. The decision buttons of FIG. 13 are an approval button and a disapproval button. The display processing unit 50 sets in the display apparatus 200 approval and disapproval for each facility change. When a facility change is disapproved, without including that change, the design changing unit 60 makes a search for a combination of facilities that can attain the energy-conservation target.

<Supplement to Hardware Structure>

In the risk calculation apparatus 101 of FIG. 2 and the risk calculation apparatus 102 of FIG. 10, the functions of the risk calculation apparatuses 101 and 102 are implemented by software. However, the functions of the risk calculation apparatuses 101 and 102 may be implemented by hardware.

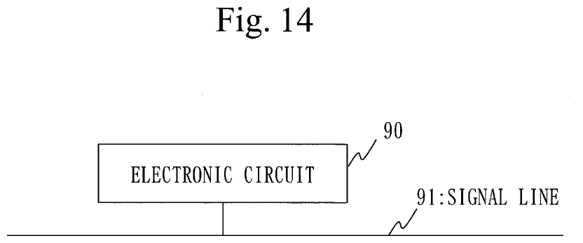

FIG. 14 illustrates a structure in which the functions of the risk calculation apparatuses 101 and 102 are implemented by hardware. An electronic circuit 90 of FIG. 14 is a dedicated electronic circuit which implements the functions of the data obtaining unit 10, the thermal environment calculation unit 20, the facility risk calculation unit 30. the evaluation unit 40, and the display processing unit 50 of the risk calculation apparatus 101; and the functions of the data obtaining unit 10, the thermal environment calculation unit 20, the facility risk calculation unit 30, the evaluation unit 40, the display processing unit 50, and the design changing unit 60 of the risk calculation apparatus 102. The electronic circuit 90 is connected to a signal line 91. The electronic circuit 90 is specifically a single circuit, composite circuit, programmed processor, parallel-programmed processor, logic IC, GA, ASIC, or FPGA. GA is an abbreviation of Gate Array. ASIC is an abbreviation of Application Specific Integrated Circuit. FPGA is an abbreviation of Field-Programmable Gate Array. The functions of the components of the risk calculation apparatuses 101 and 102 may be implemented by a single electronic circuit or may be implemented as being dispersed into a plurality of electronic circuits. Also, part of the functions of the components of the risk calculation apparatuses 101 and 102 may be implemented by an electronic circuit and the remaining functions may be implemented by software.

Each of the processor 110 and the electronic circuit 90 is also referred to as processing circuitry. In the risk calculation apparatuses 101 and 102, the functions of the data obtaining unit 10, the thermal environment calculation unit 20, the facility risk calculation unit 30, the evaluation unit 40, the display processing unit 50, and the design changing unit 60 may be implemented by processing circuitry.

While Embodiment 1 has been described above, in Embodiment 1 including the modification example, one may be partially implemented. Alternatively, in Embodiment including the modification example, two or more may be partially combined for implementation. Note that the present invention is not limited to Embodiment 1 but can be variously changed as required.

### REFERENCE SIGNS LIST

10: data obtaining unit; 20: thermal environment calculation unit; 30: facility risk calculation unit; 40: evaluation unit; 50: display processing unit; 60: design changing unit; 70: facility database; 90: electronic circuit; 91: signal line; 101, 102: risk calculation apparatus; 103: risk calculation program; 110: processor; 120: main storage device; 130: auxiliary storage device; 140: input IF; 150: output IF; 160: communication IF; 170: signal line; 200: display apparatus

1. A risk calculation apparatus comprising:
processing circuitry to:
obtain simulation data including specification data of an air-conditioning facility, architectural data of an architecture to be air-conditioned by the air-conditioning facility, and a target value serving as a target for air-conditioning of the architecture by the air-conditioning facility, the simulation data being used in calculation of a thermal environment of the architecture;
calculate, by using the simulation data, the thermal environment of the architecture to be air-conditioned by the air-conditioning facility;
calculate a facility risk by using the result of calculation of the thermal environment, the facility risk indicating at least either of a degree of difference indicating a difference between a calculated target value obtained by the calculation of the thermal environment with respect to the target value and the target value and a degree of change indicating a value of a change of the calculated target value with respect to time; and
output the facility risk.

2. The risk calculation apparatus according to claim 1, wherein the processing circuitry:
performs the calculation of the thermal environment for each step associated with time, and
calculates one said degree of difference targeted for a plurality of consecutive steps.

3. The risk calculation apparatus according to claim 2, wherein the processing circuitry calculates the one said degree of difference targeted for two consecutive steps.

4. The risk calculation apparatus according to claim 1, wherein the processing circuitry:
performs the calculation of the thermal environment for each step associated with time, and
calculates one said degree of change targeted for a plurality of consecutive steps.

5. The risk calculation apparatus according to claim 4, wherein the processing circuitry calculates the one said degree of change targeted for three consecutive steps.

6. The risk calculation apparatus according to claim 1, wherein:
the simulation data includes use-purpose information indicating a use purpose of a room to be air-conditioned by the air-conditioning facility, and
the processing circuitry corrects the facility risk in accordance with the type of the use-purpose information.

7. The risk calculation apparatus according to claim 1, wherein the processing circuitry:
calculates an amount of energy consumption of the air-conditioning facility by the calculation of the thermal environment,
calculates, by using the amount of energy consumption, an effect of reduction of the amount of energy consumption by the air-conditioning facility, and
outputs the effect of reduction.

8. The risk calculation apparatus according to claim 7, wherein the processing circuitry:
extracts another facility capable of replacing part of facilities included in the air-conditioning facility if the effect of reduction has not attained a reduction target, and
causes the extracted other facility to be displayed on a display apparatus.

9. The risk calculation apparatus according to claim 8, wherein the processing circuitry causes a decision button for asking for a decision about whether to adopt the extracted other facility to be displayed on the display apparatus.

10. A non-transitory computer readable medium storing a risk calculation program that causes a computer to execute:
a data obtaining process of obtaining simulation data including specification data of an air-conditioning facility, architectural data of an architecture to be air-conditioned by the air-conditioning facility, and a target value serving as a target for air-conditioning of the architecture by the air-conditioning facility, the simulation data being used in calculation of a thermal environment of the architecture;
a thermal environment calculation process of calculating, by using the simulation data, the thermal environment of the architecture to be air-conditioned by the air-conditioning facility;
a facility risk calculation process of calculating a facility risk by using the result of calculation of the thermal environment, the facility risk indicating at least either of a degree of difference indicating a difference between a calculated target value obtained by the calculation of the thermal environment with respect to the target value and the target value and a degree of change indicating a value of a change of the calculated target value with respect to time; and
an output process of outputting the facility risk.

11. A risk calculation method comprising:
obtaining simulation data including specification data of an air-conditioning facility, architectural data of an architecture to be air-conditioned by the air-conditioning facility, and a target value serving as a target for air-conditioning of the architecture by the air-conditioning facility, the simulation data being used in calculation of a thermal environment of the architecture;
calculating, by using the simulation data, the thermal environment of the architecture to be air-conditioned by the air-conditioning facility;
calculating a facility risk by using the result of calculation of the thermal environment, the facility risk indicating at least either of a degree of difference indicating a difference between a calculated target value obtained by the calculation of the thermal environment with respect to the target value and the target value and a degree of change indicating a value of a change of the calculated target value with respect to time; and
outputting the facility risk.
